(19) United States
(12) Patent Application Publication
(10) Pub. No.: US 2003/0086550 A1
(43) Pub. Date: May 8, 2003

(54) Gateway apparatus for transporting electrical telephony signals

(76) Inventors: Yehuda Hershkovits, Moshav Kfar HaNagid (IL); Yoram Stettiner, Hod Hasharon (IL)

Correspondence Address: Eitan, Pearl, Latzer & Cohen-Zedek,LLP., 10 ROCKEFELLER PLAZA, SUITE 1001, NEW YORK, NY, 10020, US

(21) Appl. No.: 09/986,452

(22) Filed: Nov. 8, 2001

(51) Int. Cl. H04M 7/00

(52) U.S. Cl. 379/221.03

(57) ABSTRACT

There are disclosed systems, apparatus and methods for rerouting telephony signals in the case of a front card failure, through the standby or redundant front cards, as well as standby or redundant rear cards. These redundant cards are coupled with through or bussed connections at connection areas assembled with connectors P2/rP2 (of the Compact PCI® Standard) This allows the standby or redundant front card, to operate in place of the failed front card, using the corresponding rear card.

### TECHNICAL FIELD

The present invention is directed to the transport of electrical telephony signals, and in particular, to transport of electrical telephony signals from electrical telephony interfaces through backplanes, from active cards to standby cards, to compensate for failures in any one of the active cards.

### BACKGROUND

In telecommunications systems, reliability is critical, as standards for inoperative time are exacting. These standards typically require 99.999 percent availability, which translates to 5.3 minutes per year of inoperative time. To achieve this high availability, it is necessary to eliminate single points of failure (SPOF), such that a failure at any single point in the system will not cause service degradation or an outage of the system.

In attempting to eliminate SPOF's, equipment manufacturers have attempted to employ redundancy. In conventional telephony systems redundancy is typically achieved by two approaches. These approaches are known as “N+N” or “N:N”, and “N+1”.

The first or “N+N” or “N:N” approach provides redundancy by duplicating hardware. This solution is reliable, but extremely expensive and is typically implemented for single and bottleneck elements, such as the Central Processing Unit (CPU) card or switch fabric, in which case N=1. Multiple elements require corresponding multiple duplications, and therefore, such systems are costly to build and maintain.

The other or “N+1” approach employs standby elements, with each standby element protecting N other similar elements. This approach is more difficult to implement than the “N+N” approach, but is more cost-effective, and is usually employed for power supplies, fans, discs, and telephony interface boards. Protecting an element that is hooked to external cables, such as telephony boards, is a complex task, since the standby element should interface the same cables of the failed element. In some cases, higher level protocols are defined to support such redundancy, by provisioning a redundant cable hooked to the redundant element that will be used to carry the traffic of the failed element. An example for such a protocol is SONET Automatic Protection Switching (APS). However, most of the electrical telephony interfaces, for example, T1, E1, J1, STS-1, T3 and E3, do not provide that type of support for redundancy.

Manufacturers seeking to utilize open standards, such as those of Compact Peripheral Component Interconnect (cPCI or compact PCI) have been unable to achieve this desired redundancy. The cPCI is a standard in accordance with specifications detailed in CompactPCI® Specification PICMG 2.0 R3.0, Oct. 1, 1999, from PCI Industrial Computers Manufacturers Group (PICMG), this document is incorporated by reference in its entirety herein (and referred to hereinafter as “the cPCI Standard”). This cPCI standard is designed for connecting the elements of industrial computers in a generally rugged fashion.

For example, turning to FIGS. 1a, 1b, 2a and 2b, there are detailed standard implementations of compact PCI systems 10 (FIGS. 1a and 1b) and 10′ (FIGS. 2a and 2b). The system 10 of FIGS. 1a and 1b is based on a 32 bit PCI backplane, while the other system 10′ of FIGS. 2a and 2b is based on a 64 bit PCI backplane.

Turning now to FIGS. 1a and 1b, the system 10 includes a box or card cage (not shown) with a backplane 20, having connection areas 22, and front 24 and rear 25 sides. Slots 28, 29 (shown for one front/rear card arrangement with respect to the backplane 20) are on the respective front 24 and rear 25 sides at the connection areas 22. The connection areas 22 on the front side 24 support connectors 28a, that are designated with the prefix “P” and are numbered from 1-5 from bottom to top (P1-P5), while these connection areas 22 on the rear side 25 support connectors 29a, that are designated with the prefix “rP”, and similarly numbered from 1-5 from bottom to top, so as to be referred to as rP1-rP5.

The slots 28, 29 typically include male pin headings, and are designed to engage connectors 40, 41, typically including female receptacles, correspondingly labeled, with the prefix “J” or “rJ”, (and numbered 1-5 from bottom to top, as detailed above) into those of the connection areas 22, on boards or cards 44, 45, and here, for example, card 44 is on the front side 24 and thus, a “front” card (having connectors J1-J5J), while card 45 is on the rear side 25 and thus, is a “rear” card (having connectors rJ1-rJ5).

Throughout this document and in the accompanying drawing figures, connectors may be referred to as such, or referred to by their positions alone, for example, P1-P5, rP1-rP5, J1-J5, rJ1-rJ5. Additionally, connectors at positions P3, P4, rP3, rP4, J3, J4, rJ3 and rJ4 (shown in FIGS. 1a, 2a and 4), are also part of the respective systems/apparatus 10, 10′, 100, 100′, 200 and 200′ detailed herein and shown in FIGS. 1b, 2b, 3, 5, 6a and 6b, respectively, but are not shown in these drawing figures, in order to emphasize the invention.

In accordance with the cPCI standard, the connection areas 22 and respective slots 28, 29, may form two main types of connections. These connections include “through” connections and “bussed” connections. The definitions of “through” and “bussed” for connections and connectors that are detailed immediately below are applicable throughout this document.

Through connections are those that penetrate the backplane 20 and reach the front card, here, card 44, and the rear card, here, card 45. In the cPCI standard, through connections do not connect to electrical traces in the backplane 20. These connections are typically used to provide connectivity between the respective front card and external signals, interfaced to the associated rear card.

Bussed connections are those that are specific to either front cards, here card 44, or rear cards, here card 45, and penetrate the backplane 20 but only from either the front side or rear side, and connect to the electrical traces in the backplane 20. These connections are typically used to provide connectivity between two or more front cards.

In accordance with this cPCI standard, “bussed” traces in the backplane are only accessed by front cards using bussed connections. Moreover, the front cards only communicate with rear cards by through connections. In accordance with the cPCI standard, rear cards can not reach the bussed traces in the backplane, for example, for transporting PSTN signals.

Turning also to FIG. 1b, the backplane 20 is a 32 bit PCI backplane, with connection area 22 supporting connector P1, that accommodates a bussed connection, while connector P2 accommodates a through connection. Front cards 44, without any backup, connect to the backplane 20 at connectors P1, P2 and P5, while rear I/O cards 45 connect to the backplane 20 at connectors rP2 and rP5. This results in through connections between corresponding telephony traces 46 on front 44 and rear 45 cards at P2-rP2 and P5-rP5, through which, for example, a T1 signal is transported.

Turning now to FIGS. 2a and 2b, there is a system 10′ employing a 64 bit PCI backplane 80. This backplane 80 is similar to backplane 20, except that connection areas 22 support connectors P1 and P2, both for accommodating bussed connections Here, front cards 82, that are all active, connect to the backplane 80 in slots 84 at connectors 84a, positioned at P1, P2 and P5, while rear Input/Output (I/O) cards 85 connect to the backplane 80 in a slot 87 at the connector 87a, positioned at rP5. P5 and rP5 form a through connection, through which telephony signals are transported along corresponding telephony traces 88. This system 10′ exhibits drawbacks similar to those detailed above for the system 10.

Both systems 10 and 10′ exhibit additional drawbacks. The cPCI standard fails to dedicate electrical traces in the backplane for transmitting telephony signals over the backplane and provide access to these traces via rear card, where telephony cables are interfaced. Accordingly, in the case of a front card failure, telephony signals can not be rerouted by the corresponding rear card to another card, without dropping established connections or affecting service availability.

### SUMMARY

The present invention improves on the contemporary art by providing systems, apparatus and methods for rerouting telephony signals in the case of a front card failure, without having to unplug all Input/Output (I/O) cards. The present invention provides standby or redundant front cards, as well as standby or redundant rear cards, coupled with through or bussed connections at connectors P2/rP2 (of the cPCI standard). This allows the standby or redundant front card, to operate in place of the failed front card, using the corresponding rear card.

One embodiment of the present invention is directed to an apparatus for transferring electrical telephony transmissions. The apparatus comprises a backplane including front and rear sides, with this backplane having at least a first slot on the front side and the rear side, and at least a second slot on the front side and the rear side. The first and second slots on the respective front and rear sides of the backplane are configured for supporting respective front and rear cards, each of them including at least a first connection area and at least a second connection area. The at least a first connection area and the backplane are configured for supporting 32 bit PCI communications therebetween, while the at least a second connection area is coupled with the at least a first connection area, and the backplane is configured for supporting 64 bit PCI communications therebetween. The at least one second connection area includes at least one through connector for facilitating at least electrical telephony transmissions between at least one rear card in the at least one first slot and either of the at least one rear card or the at least one front card in the second slot.

Another embodiment of the invention is directed to an another apparatus for transferring electrical telephony transmissions. The apparatus has a backplane including front and rear sides, and has at least a plurality of bussed traces; at least first and second slots on the front and rear sides of the backplane, for supporting front and rear cards. Each of the slots includes at least a first connection area and at least a second connection area. The at least a first connection area includes a plurality of first connector openings (for receiving pins), while the at least a second connection area includes a plurality of second connector openings (for receiving pins), at least one of the connector openings providing connectivity to the plurality of bussed traces. The at least one second connection area includes at least one through connector, for example, formed by connectors at P2 and rP2 connecting with connectors at J2 and rJ2, respectively, for facilitating at least electrical telephony transmissions between at least one rear card in said at least one first slot and either of the at least one rear card or the at least one front card in the second slot along at least one of said plurality of bussed traces.

Another embodiment of the present invention is directed to a third apparatus for transferring electrical telephony transmissions. The apparatus has a backplane including front and rear sides, and has at least a first slot on the front and rear sides of the backplane and at least a second slot on the front and rear sides of the backplane. The first and second slots on said front and rear sides of the backplane are configured for supporting respective front and rear cards, each of the slots including at least a first connection area and at least a second connection area. The at least a first connection area and the backplane are configured for supporting 32 bit PCI communications therebetween; while the at least a second connection area coupled with the at least a first connection area and the backplane support 64 bit PCI communications therebetween. The at least one second connection area includes at least one bussed connector on the rear side of the backplane for facilitating at least electrical telephony transmissions between at least one rear card in the at least one first slot and either of the at least one rear card or the at least one front card in the second slot.

Another embodiment of the invention is directed to a fourth apparatus for transferring electrical telephony transmissions. The apparatus includes a backplane including front and rear sides, this backplane having at least a plurality of bussed traces and at least first and second slots on the front and rear sides of the backplane respectively, for supporting front and rear cards. Each of the slots includes at least a first connection area and at least a second connection area. The at least a first connection area includes a plurality of first connector openings (for receiving pins), and the at least a second connection area includes a plurality of second connector openings (for receiving pins), at least one of the second connector openings providing connectivity to the plurality of bussed traces. The at least one second connection area includes at least one bussed connector on the rear side of the backplane, for example, connector rP2 connecting with connector rJ2, for facilitating at least electrical telephony transmissions between at least one rear card in the at least one first slot; and either of the at least one rear card or the at least one front card in the second slot, along at least one of the plurality of bussed traces.

### BRIEF DESCRIPTION OF THE DRAWINGS

Attention is now directed to the attached drawings, wherein like reference numerals or characters indicate corresponding or like components. In the drawings:

FIG. 1a is an exploded cross-sectional view of connections in accordance with a first system in accordance with a cPCI standard;

FIG. 1b is a perspective view of the system employing the connections as per FIG. 1a;

FIG. 2a is an exploded cross-sectional view of connections in accordance with a second system in accordance with a cPCI standard;

FIG. 2b is a perspective view of the system employing the connections as per FIG. 2a;

FIG. 3 is a perspective view of a system in accordance with an embodiment of the present invention;

FIG. 4 is an exploded view of the connections for the system of FIG. 3;

FIG. 5 is a perspective view of an alternate embodiment of the invention;

FIGS. 6a and 6b are perspective views of alternate embodiments of the present invention; and

FIG. 7 is a table of pin arrangements for connector pins in accordance with the cPCI Standard.

### DETAILED DESCRIPTION OF THE DRAWINGS

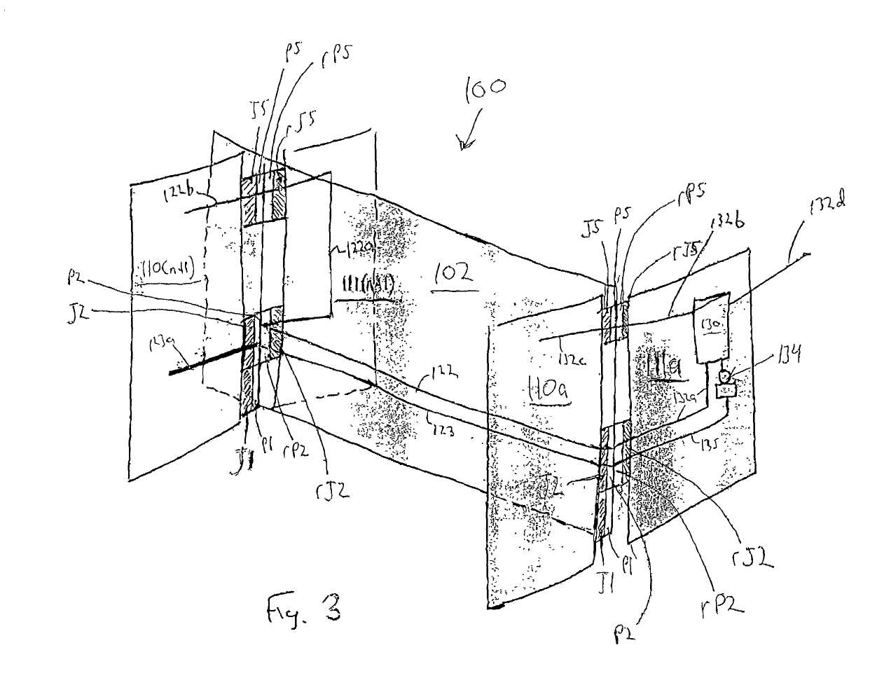

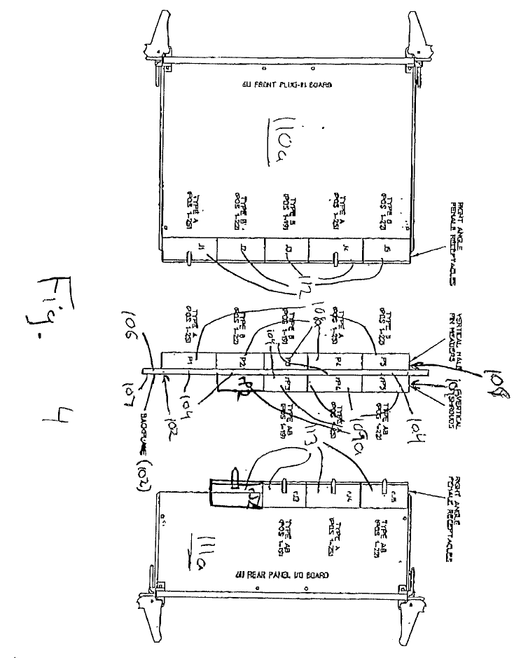

FIGS. 3 and 4 show an exemplary apparatus 100, in an example system, employed with components in accordance with a CompactPCI® Specification, PICMG 2.0 R3.0, Oct. 1, 1999 from PCI Industrial Computers Manufacturers Group (PICMG), this document incorporated by reference in its entirety herein. Here, the apparatus 100 is such that the card cage is not shown.

The apparatus 100 includes a backplane 102, typically a 64 bit PCI backplane, with connection areas 104, typically defined by multiple openings configured to receive pins (detailed below), for corresponding front and rear cards (detailed below). The backplane 102 includes front 106 and rear 107 sides, with slots 108, 109 on the respective front and rear sides thereon (in accordance with the slots 28, 29 (detailed above) and connection areas 104, with slots 108 on the front side 106, having connectors 108a labeled P1-P5 and slots 109, having connectors 109a labeled rP1-rP5 on the rear side 107. While this arrangement is shown for front card 110a (representative of active front cards 110a-110n) and rear card 111a (representative of active rear cards 111a-111n), it is exemplary for all card arrangements and connections on the backplane 102, including cards 110(n+1) (representative of standby or redundant cards 110(n+1)-110(n+m)) and 111(n+1)(representative of standby or redundant cards 111(n+1)-111(n+m)), detailed below.

Front cards 110a-110n, that are all active, are protected by at least a single standby (or redundant) card 110(n+1), and typically multiple standby or redundant cards 110(n+1) to 110(n+m), these standby or redundant cards configured for placement along this front side 104. Front cards 110a-110n can be identical in construction, or of different types for accommodating different line types. (In this case, at least one standby or redundant card is required for each series of card types). Additionally, front cards 100(n+1)-110(n+m) are typically identical in construction to the group of cards type they protect, but can be different for accommodating the protection mechanism.

Rear I/O cards 111a-111n correspond to redundant cards 111(n+1)-111(n+m). These rear cards 111a-111n and 111(n+1)-111(n+m) positionally correspond to front cards 110a-110n and 110(n+1)-110(n+m). They are configured for placement along the rear side 107.

Here, only two front cards 110a and 110(n+1) are shown. This showing of only two front cards 110a, 110(n+1) is exemplary only, as the backplane 102 is configured to receive numerous front cards, therebetween. All front cards 110a, 110(n+1) here are active, but for description purposes, the card 110(n+1), also an active card, will additionally be considered as a “standby” or “redundant” card and will be referred to as such hereinafter. These front cards 110a-110n are all of the same type and are connected to electrical telephony interfaces via the rear cards 111a-111n, and may be Voice Over Internet Protocol (VOIP) cards, Public Switched Telephone Network (PSTN) interface cards, Time Division Multiplexer (TDM) switch cards, voice recognition cards, or the like.

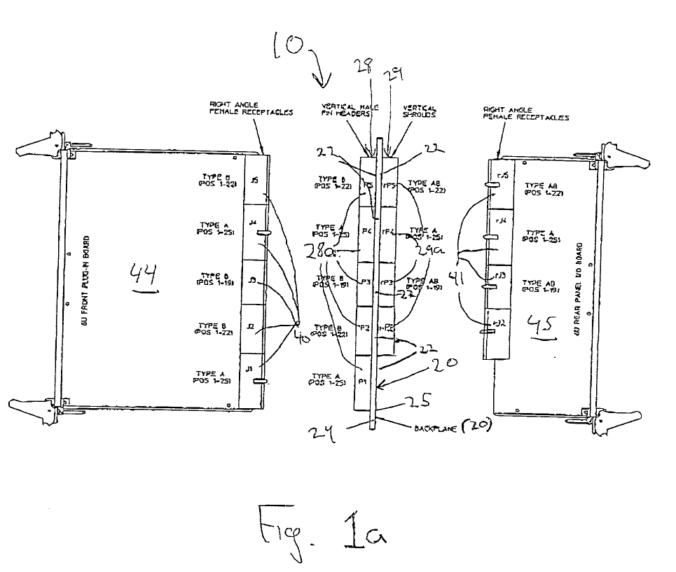

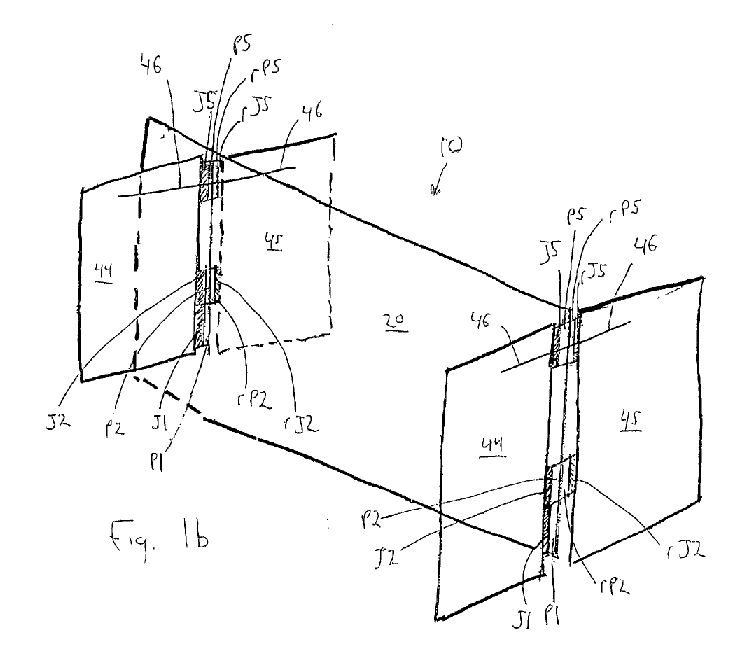

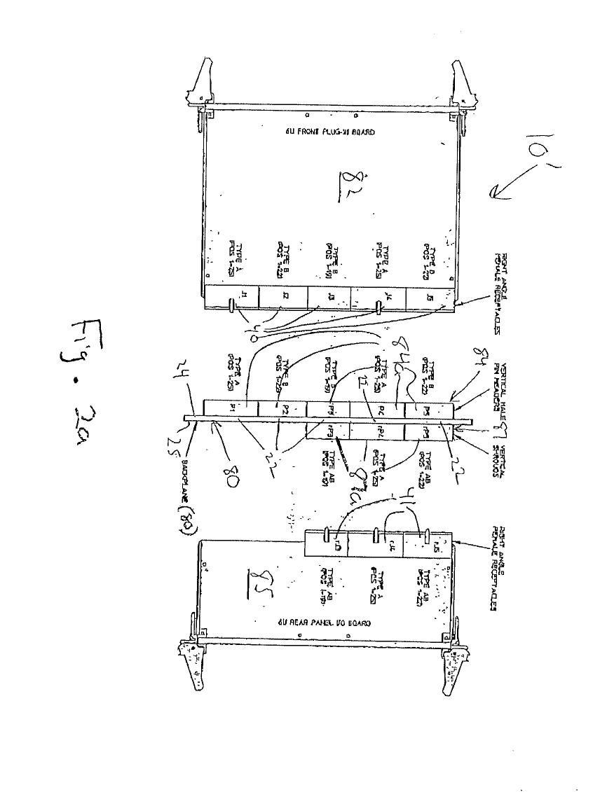

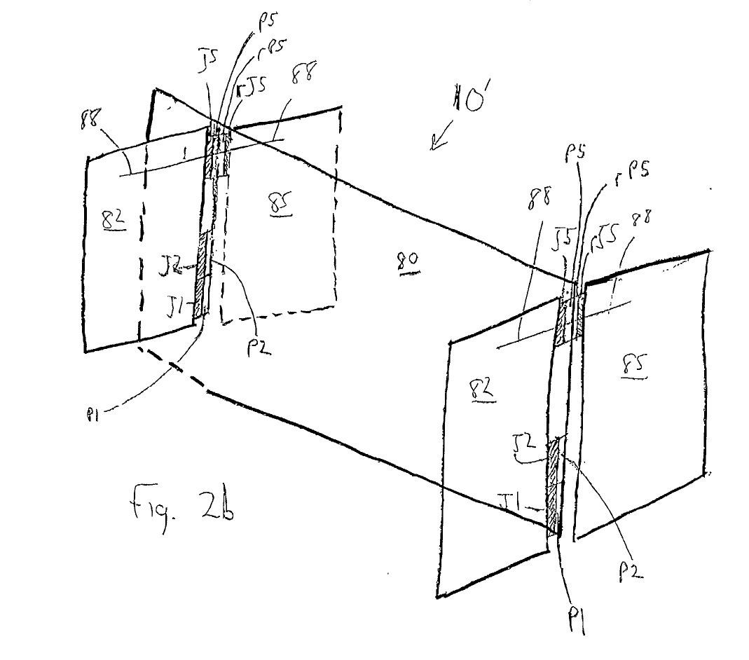

As shown in FIG. 4, in this system 100, the connections have been modified from the cPCI standard shown in FIGS. 1a and 2a and described above. Here, a through connector has been assembled on a bussed connection area, this connector, for example, P2 and corresponding rP2. As a result, there is connectivity between two or more rear (and the corresponding front) cards. This connectivity can be used to reroute telephony signals from an active rear card, for example, rear card 111a, to standby or redundant rear (or front) card 111(n+1) (or 110(n+1)). Also here, P1 and P2 connectors and the corresponding connection areas provide the power and ground feeds to the respective front 110a-110n and rear 111a-111n cards.

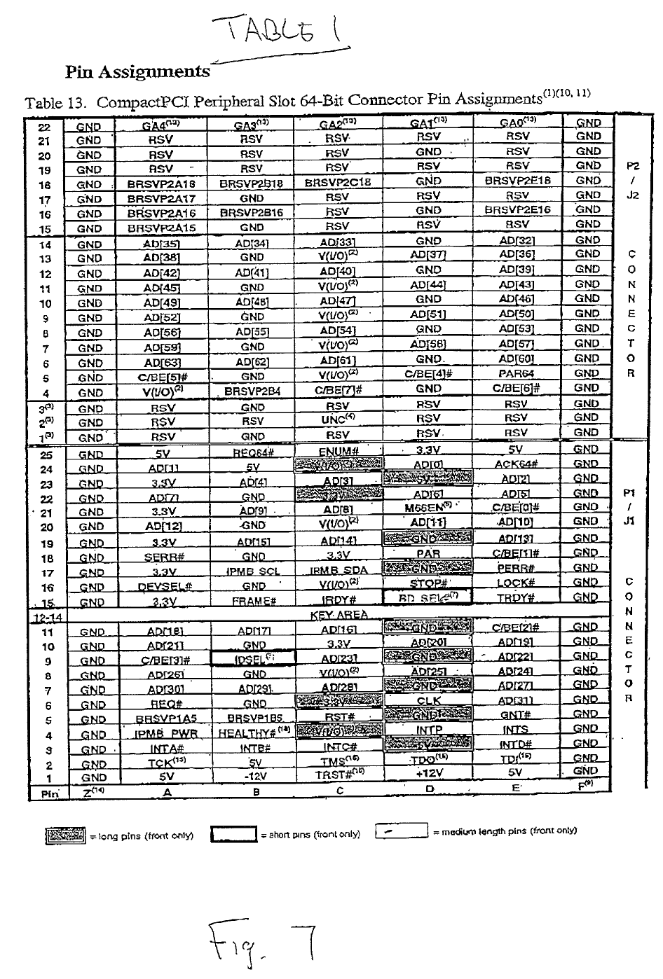

The front cards 111a-110n include connectors 112, designated J1-J5 as detailed above, and the rear cards 111 include connectors 113, correspondingly labeled rJ2-rJ5, for the respective through and bussed connectors P1-P5 and rP1-rP5, as detailed above. Connectors 112, typically at J1 and J2, and connectors 113, typically at rJ2 have openings, that receive pins (these pins at connectors 108a at positions P1, P2 and connector 109a at position rP2). These pins at P1, P2 and rP2 are, for example, arranged in configurations in accordance with corresponding cPCI standards, as shown in Table 1 of FIG. 7, resulting in connections at corresponding slots 108, 109 at connection areas 104 (only one shown, the connection area between cards 110(n+1) and 111(n+1) is similar) of the backplane 102. A telephony link, typically formed from a plurality of traces 122, and a control link 123, extend along the backplane 102, preferably between connectors 108a at the P2 positions of connection areas 104. While two links 122, 123 are shown, this is exemplary only as there can be numerous links in the backplane 102. Moreover, here, and throughout this document, a link is formed from one or more traces.

The telephony link 122 is a group of bussed traces, and as such, provides redundancy capability between the front cards 110a-110(n+m). This telephony link 122 is functional (accessible) for all active rear 111a-111n and possibly front cards 110a-110n. Functionality for the redundant rear card(s) 111(n+1)-111(n+m) is typical, as the rear cards 111a-111n route the telephony signals from the telephony link to the front card(s), for example, from rear card 111a that includes a link 122a from connector P2 to connector P5, for routing the telephony signals to P5 on the front card 110(n+1). The line type carried by this telephony link 122 depends on the coding standard and for example may be of the T1 or T3 types for the Untied States, E1 or E3 types for Europe, J1 type for Japan, STS1 type, etc.

The control link 123 is placed along the backplane 102 in a manner to allow separate control for each individual active rear card 111a-111n, by extending to the rear cards 111a-111n, as relay controls 135 (detailed below). Additionally, front cards have access to the control link, either directly (such as link 123a on card 110(n+1)) or via the corresponding rear card. Accordingly, one or more individual front cards 110a-110(n+m) can control this control link 123 and provide control to the operative rear card 111a-111(n+m).

Rear cards 111 support electrical telephony interfaces including T1, T3, E1, E3, J1, STS1, etc., as detailed above. Each active rear card 111a-111n typically includes isolation relay(s) 130, from which telephony links 132a, 132b extend, and a control circuit 134, for controlling the isolation relay 130, from which a relay control 135 extends.

The isolation relay 130 is a switching circuit, that can be mechanical or electrical, but is typically mechanical, as it is a passive component. By being a passive component, the switching circuit typically has a longer life when compared to corresponding active components. The isolation relay 130, controlled by the control circuit 134 via relay control 135, normally routes telephony signals to the front cards 110a-110(n+m) by a through connection, typically connector P5, and can be controlled by another front card to route the telephony signals through a bussed connection, here at connector P2, should the corresponding front card fail.

The telephony link 132a couples with telephony link 122, by a through connection, here for example at connector P2 while relay control 135 couples with the control trace 123, also by a through connection, here for example at connector P2. Additional telephony links, such as telephony link 132b, can also couple links 132c on front cards via the through connection at connector P5. Link 132d is an external telephony link to external sources of telephony transmissions, that can be for example, T1, T3, E1, E3, J1, STS1, etc.

Alternate embodiments of the apparatus 100 may include mixtures of telephony interfaces (for example, types T1, T3, E1, E3, J1, STS1, etc., as detailed above) on the same or a different rear I/O card. In this case there would be more than one “standby” or “redundant” card, represented by 110(n+1) above, for example, one standby or redundant card for each telephone interface type.

Still other alternate embodiments of the apparatus may involve horizontally segmenting the connection area in the backplane that serves connectors P2 and rP2. For example, a first segment may be for an E1 interface cards while a second segment may be for T3 interface cards. Here, one card of each type may fail, with the system continuing to operate properly.

In an exemplary operation of apparatus 100, normal transmissions go from rear card 111a to front card 110a, over a through connector P5. Should front card 110a fail, standby front card 110(n+1) will become operative, whereby relay control 130, upon receiving a signal via control link 123 (via control link 123a from standby card 110(n+1)) will switch telephony link 132b to 132a. The signals will then reach the bussed connection at connector P2 and travel along telephony link 122 to rear card 111(n+1). The transmission then travels on telephony link 122a, until passed into telephony link 122b on front card 110(n+1) through a through connection at connector P5. This transmission path allows for uninterrupted, normal functioning of the system should there be a front card failure.

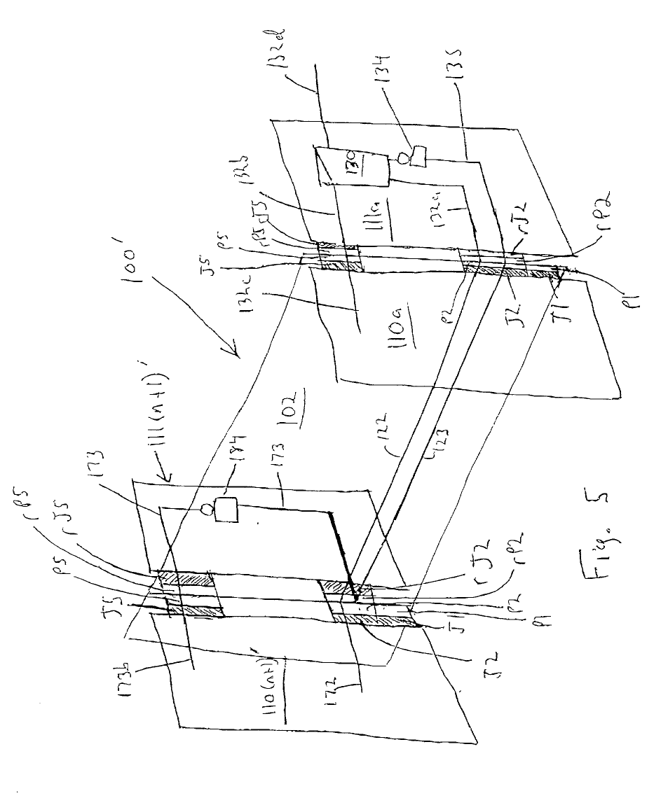

FIG. 5 details an alternate embodiment to FIGS. 3 and 4. The system 100′ is similar in construction and arrangement to the systems of FIGS. 3 and 4 (detailed above), except where indicated. Here, the standby or redundant front card 110(n+1)′ is configured to receive rerouted telephony signals at link 172 through the through connection at connector P2, while control is obtained through connector P5. A link 173, typically coupled with a control link 173b on the standby front card 110(n+1)′, when signaled, activates control circuitry 184 (similar to component 134 detailed above). Link 173 on rear card 111 (n+1)′ terminates at control link 123, whereby telephony signals are carried to the control circuit 134, via link 135.

In operation here, the control circuit 134 signals the relay control 130, as detailed above. This results in the telephony links switching from link 132b to links 132a, such that signals are transmitted via the through connection at connector P2, and along the backplane by link 122, with these rerouted telephony signals received at link 172 via the through connector P2.

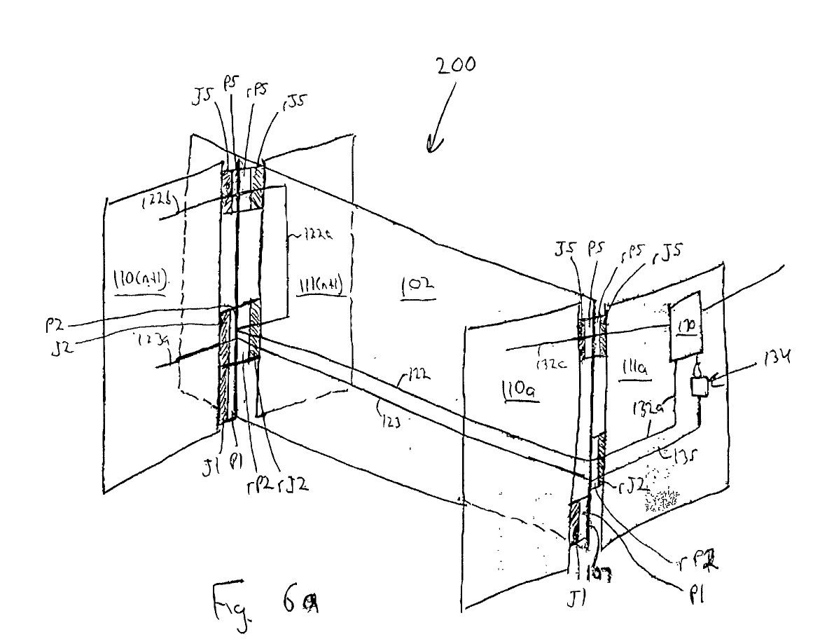

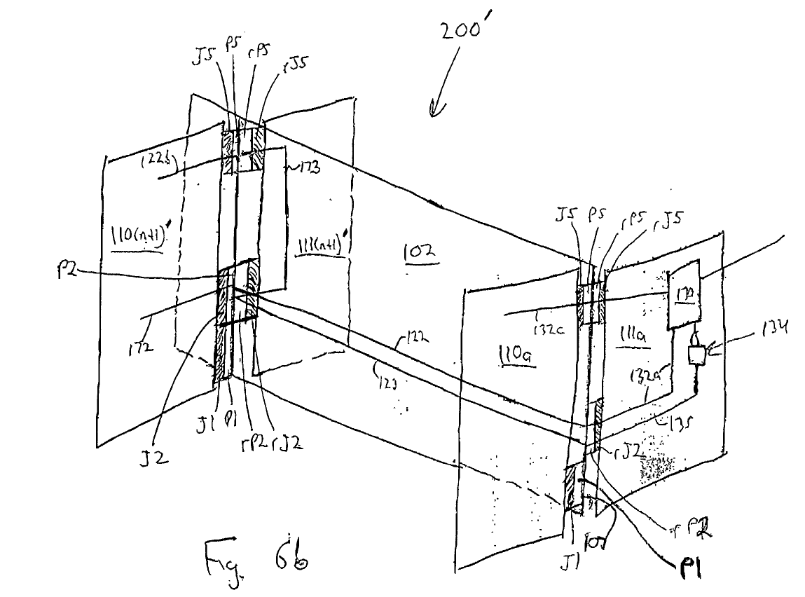

FIGS. 6a and 6b show systems 200, 200′ that are alternate embodiments with respect to systems 100, 100′, that are detailed above. In these systems 200, 200′, the through connection at connector P2 on front card/rear card set 110a-111a (from the system 100, 100′ detailed above) has been replaced by a bussed connection only at the rear side 107, of the backplane 102. System 200 is similar in construction and arrangement to the system of FIGS. 3 and 4, while system 200′ is similar in construction and arrangement to the system of FIG. 5, such that components thereof, except where indicated, have been described above.

While preferred embodiments of the present invention have been described, with exemplary components and configurations thereof, so as to enable one of skill in the art to practice the present invention, the preceding description is intended to be exemplary only. It should not be used to limit the scope of the invention, which should be determined by reference to the following claims.

What is claimed is:

1. An apparatus for transferring electrical telephony transmissions comprising:
a backplane including front and rear sides, comprising:
at least a first slot on said front side and rear side of said backplane and at least a second slot on said front side and said rear side of said backplane, said first and second slots on said front and rear sides of said backplane respectively, configured for supporting respective front and rear cards, each of said slots including at least a first connection area and at least a second connection area;
said at least a first connection area and said backplane configured for supporting 32 bit PCI communications therebetween;
said at least a second connection area coupled with said at least a first connection area and said backplane is configured for supporting 64 bit PCI communications therebetween;
said at least one second connection area including at least one through connector for facilitating at least electrical telephony transmissions between at least one rear card in said at least one first slot and either of said at least one rear card or said at least one front card in said second slot.

2.The apparatus of claim 1, wherein said backplane includes at least one control link.

3. The apparatus of claim 1, wherein said backplane includes a 64 bit PCI backplane.

4. The apparatus of claim 1, additionally comprising a plurality of front cards and a plurality of rear cards, said front and rear cards in said respective first and second slots on said front and rear sides of said backplane.

5. The apparatus of claim 4, wherein at least one of said front cards is in communication with said control link, and configured for controlling at least electrical telephony transmissions from at least one rear card.

6. The apparatus of claim 1, wherein said backplane is configured for transporting electrical telephony transmissions.

7. The apparatus of claim 6, wherein said electrical telephony transmissions are selected from the group comprising; T1, T3, E1, E3, J1, STS1.

8. An apparatus for transferring electrical telephony transmissions comprising:
a backplane including front and rear sides, comprising:
at least a plurality of bussed traces;
at least first and second slots on said front and rear sides of said backplane respectively for supporting front and rear cards, each of said slots including at least a first connection area and at least a second connection area,
said at least a first connection area comprising a plurality of first connector openings;
said at least a second connection area comprising a plurality of second connector openings, at least one of said connector openings providing connectivity to said plurality of bussed traces;
said at least one second connection area including at least one through connector for facilitating at least electrical telephony transmissions between at least one rear card in said at least one first slot and either of said at least one rear card or said at least one front card in said second slot along at least one of said plurality of bussed traces.

9. The apparatus of claim 8, wherein said first connector openings are defined in accordance with a P1 connector in a cPCI standard.

10. The apparatus of claim 8, wherein said second connector openings include at least power and ground openings, said power and ground openings arranged in accordance with the power and ground openings in the P2 connector of a cPCI standard.

11. The apparatus of claim 8, wherein said first connector openings include at least power and ground openings, said power and ground openings arranged in accordance with the power and ground openings in the P1 connector of a cPCI standard.

12. The apparatus of claim 8, wherein said at least one of said plurality of bussed traces includes a control link.

13. The apparatus of claim 12, wherein at least one of said front cards is in communication with said control link, and configured for controlling at least electrical telephony transmissions from at least one rear card.

14. The apparatus of claim 8, wherein said electrical telephony transmissions are selected from the group comprising: T1, T3, E1, E3, J1, STS1.

15. An apparatus for transferring electrical telephony transmissions comprising:
a backplane including front and rear sides, comprising:
at least a first slot on said front and rear sides of said backplane and at least a second slot on said front and rear sides of said backplane, said first and second slots on said front and rear sides of said backplane respectively configured for supporting respective front and rear cards, each of said slots including at least a first connection area and at least a second connection area;
said at least a first connection area and said backplane configured for supporting 32 bit PCI communications therebetween;
said at least a second connection area coupled with said at least a first connection area and said backplane for supporting 64 bit PCI communications therebetween;
said at least one second connection area including at least one bussed connector on said rear side for facilitating at least electrical telephony transmissions between at least one rear card in said at least one first slot and either of said at least one rear card or said at least one front card in said second slot.

16. The apparatus of claim 15, wherein said backplane includes at least one control link.

17. The apparatus of claim 15, wherein said backplane includes a 64 bit PCI backplane.

18. The apparatus of claim 15, additionally comprising a plurality of front cards and a plurality of rear cards, said front and rear cards in said respective first and second slots on said front and rear sides of said backplane.

19. The apparatus of claim 18, wherein at least one of said front cards is in communication with said control trace, and configured for controlling at least electrical telephony transmissions from at least one rear card.

20. The apparatus of claim 15, wherein said electrical telephony transmissions are selected from the group comprising: T1, T3, E1, E3, J1, STS1.

21. An apparatus for transferring electrical telephony transmissions comprising:
a backplane including front and rear sides, comprising:
at least a plurality of bussed traces;
at least first and second slots on said front and rear sides of said backplane respectively for supporting front and rear cards, each of said slots including at least a first connection area and at least a second connection area;
said at least a first connection area comprising a plurality of first connector openings;
said at least a second connection area comprising a plurality of second connector openings, at least one of said second connector openings providing connectivity to said plurality of bussed traces;
said at least one second connection area including at least one bussed connector for facilitating at least electrical telephony transmissions between at least one rear card in said at least one first slot and either of said at least one rear card or said at least one front card in said second slot.

22. The apparatus of claim 21, wherein said first connector openings are defined in accordance with a P1 connector in a cPCI standard.

23. The apparatus of claim 21, wherein said second connector openings include at least power and ground openings, said power and ground openings arranged in accordance with the power and ground openings in the P2 connector of a cPCI standard.

24. The apparatus of claim 21, wherein said first connector openings include at least power and ground openings, said power and ground openings arranged in accordance with the power and ground openings in the P1 connector of a cPCI standard.

25. The apparatus of claim 21, wherein said at least one of said plurality of bussed traces includes a control link.

26. The apparatus of claim 25, wherein at least one of said front cards is in communication with said control link, and configured for controlling at least electrical telephony transmissions from at least one rear card.

27. The apparatus of claim 21, wherein said electrical telephony transmissions are selected from the group comprising: T1, T3, E1, E3, J1, STS1.
